(19) United States
(12) Patent Application Publication
(10) Pub. No.: US 2025/0360440 A1
(43) Pub. Date: Nov. 27, 2025

(54) GARBAGE COLLECTION SYSTEM

(71) Applicant: Shenzhen Aiper Intelligent Co., Ltd., Shenzhen (CN)

(72) Inventor: Minxing LI, Suzhou (CN)

(73) Assignee: Shenzhen Aiper Intelligent Co., Ltd., Shenzhen (CN)

(21) Appl. No.: 19/291,704

(22) Filed: Aug. 6, 2025

(30) Foreign Application Priority Data
Jan. 26, 2025 (CN) 2025201754423

(51) Int. Cl. B01D 29/64; B05B 3/02; C02F 1/00; C02F 103/42; E04H 4/16

(52) U.S. Cl. CPC B01D 29/6446; B05B 3/02; C02F 1/001; E04H 4/1654; C02F 2103/42; C02F 2201/008; C02F 2303/16

(57) ABSTRACT

The present disclosure relates to the technical field of cleaning device and discloses a garbage collection system, including a landing assistance mechanism, a base station and a controller. The base station includes a holding section for a pool automatic cleaning device, a garbage collection device and a water flow guiding mechanism. In a case where the pool automatic cleaning device is located at the holding section, a filtering device of the pool automatic cleaning device is interconnected to the garbage collection device, and the controller is configured to control the water flow guiding mechanism to perform water spraying, so as to move garbage in the filtering device from the filtering device to the garbage collection device.

### CROSS-REFERENCE TO RELATED APPLICATION

This application claims priority to Chinese Patent Application No. 202520175442.3, filed on Jan. 26, 2025, which is hereby incorporated by reference in its entirety.

### FIELD

The present disclosure relates to the technical field of cleaning devices, and in particular, to a garbage collection system for pool cleaning.

### BACKGROUND

In a case where a pool automatic cleaning device is working underwater for a long time, garbage in a garbage basket keeps increasing. At this time, users need to manually clear the garbage in the garbage basket, and the degree of automation is very low. In the present disclosure, a garbage collection device is disposed on a shore of a pool. When there is a large amount of garbage in the garbage basket of the pool automatic cleaning device that needs to be cleared, the pool automatic cleaning device can go to the garbage collection device located on the shore of the pool by the landing assistance mechanism and connect with the garbage collection device, thereby achieving fully automatic garbage collection

### SUMMARY

In order to solve the above-mentioned technical problems, the present disclosure provides a garbage collection system. The garbage collection system can automatically collect dirt or garbage in the filtering device of the pool automatic cleaning device, ensuring that the dirt or garbage in the pool automatic cleaning device can enter the base station during a collection process, and the entire process does not require user participation.

To achieve the above-mentioned purpose, embodiments of the present disclosure provide a garbage collection system.

A garbage collection system, including a landing assistance mechanism, a base station and a controller, wherein: the base station includes a holding section for a pool automatic cleaning device, a garbage collection device and a water flow guiding mechanism; the landing assistance mechanism is used to assist the pool automatic cleaning device in moving from an inside of a pool to the holding section on a shore of the pool; wherein in a case where the pool automatic cleaning device is located at the holding section, a filtering device of the pool automatic cleaning device is interconnected to the garbage collection device, and the controller is configured to control the water flow guiding mechanism to perform water spraying, so as to move garbage in the filtering device from the filtering device to the garbage collection device.

In one or more embodiments, a water outlet of the water flow guiding mechanism is disposed below the filtering device, so that a water flow from the water outlet rinses at least a portion of the filtering device from a bottom of the filtering device to guide the garbage in the filtering device to flow into the garbage collection device.

In one or more embodiments, a water outlet of the water flow guiding mechanism is disposed above the filtering device or near a top of a garbage basket, so that a water flow from the water outlet rinses at least a portion of the filtering device from a top of the filtering device or a side of the filtering device to guide the garbage in the filtering device to flow into the garbage collection device.

In one or more embodiments, the water flow guiding mechanism stretches upwards to allow the water outlet to reach the top of the filtering device.

In one or more embodiments, the water flow guiding mechanism is tubular or showerhead shaped.

In one or more embodiments, the water flow from the water outlet flows to an inside and/or outside of the filtering device.

In one or more embodiments, the garbage collection device further includes a conveyor belt and a garbage accommodating device, and the garbage in the filtering device is conveyed into the garbage accommodating device by the conveyor belt.

In one or more embodiments, the water outlet of the water flow guiding mechanism further includes a rotating nozzle, and the rotating nozzle is configured to spray water intermittently or in a pulsed manner.

In one or more embodiments, the landing assistance mechanism includes at least one of the following forms: a lifting device which is provided with a supporting surface that is configured to move up and down, and the pool automatic cleaning device is moved, by the supporting surface, from the inside of the pool to the holding section for the pool automatic cleaning device; a climbing mechanism which is provided with a guiding surface, and the pool automatic cleaning device moves, by the guiding surface, from the inside of the pool to the holding section for the pool automatic cleaning device; and a hoisting mechanism which is provided with an upward force-applying element, and the pool automatic cleaning device is moved, by the upward force-applying element, from the inside of the pool to the holding section for the pool automatic cleaning device.

In one or more embodiments, the water flow guiding mechanism includes a suction device, a suction pipe and a discharge pipe, and in a case where the suction device is working, the suction pipe sucks water from the inside of the pool or an external water pipe, and the discharge pipe discharges filtered water out of the garbage collection system.

In one or more embodiments, the suction device is disposed on the garbage collection device, the suction pipe, or the discharge pipe.

In one or more embodiments, the base station and/or at least part of the landing assistance mechanism is disposed on a shore of the pool.

In one or more embodiments, further including: a detection device which is used to detect whether the pool automatic cleaning device is properly connected to the holding section and/or whether a dirt amount in the filtering device reaches a collecting threshold, and whether the garbage collection system collects garbage is controlled based on a detection signal of the detection device.

In one or more embodiments, the filtering device further includes a bottom cover, and the bottom cover is configured to be opened in a case where the garbage collection system is conducting garbage collection.

In one or more embodiments, a dirt suction port at the bottom of the pool automatic cleaning device and a dirt suction port of the filtering device are configured to be expanded in a case where the garbage collection system is conducting garbage collection.

In one or more embodiments, further including: a wireless charging device, and in a case where the pool automatic cleaning device is located at the holding section, the garbage collection system charges the pool automatic cleaning device by the wireless charging device.

Implementing the embodiments of the present disclosure has the following beneficial effects.

By setting a garbage collection system, in a case where there is a large amount of garbage in the garbage basket of the pool automatic cleaning device that needs to be cleared, the pool automatic cleaning device can go to the garbage collection device located by the shore of the pool through the landing assistance mechanism and interconnect to the garbage collection device, thereby achieving the function of automatic return to the base station and self-cleaning.

In addition, since the garbage is adsorbed in the filtering device, it needs to be separated from the filtering device by external force. Therefore, the water flow guiding mechanism is disposed. The garbage is flushed away by the force of the water flow, so that the garbage enters the garbage collection device with the water flow.

Finally, the present disclosure provides a fully automatic solution for garbage collection, enabling fully automated processing of pool automatic cleaning device from the inside of the pool to garbage collection on the base station, without the need for user participation.

### BRIEF DESCRIPTION OF THE DRAWINGS

In order to more clearly illustrate technical solutions of the present disclosure, a brief introduction will be made below to the accompanying drawings required for use in the embodiments or related technical descriptions. Obviously, the accompanying drawings described below are only some embodiments of the present disclosure. For persons skilled in the art, without making creative efforts, other accompanying drawings can still be obtained based on these accompanying drawings.

FIG. 1 is a structural diagram of a pool automatic cleaning device of an embodiment of the present disclosure.

FIG. 2 is a schematic diagram of a garbage collection system of an embodiment of the present disclosure.

FIG. 3 is a schematic diagram of a pool automatic cleaning device of an embodiment of the present disclosure.

FIG. 4 is a structural diagram of a landing assistance mechanism of an embodiment of the present disclosure.

The reference numerals in the accompanying drawings correspond to: 1—landing assistance mechanism; 11—lifting device; 111—supporting surface; 112—guide column; 2—base station; 21—holding section; 22—garbage collection device; 23—water flow guiding mechanism; 231—suction device; 232—suction pipe; 70—pool automatic cleaning device; 71—filtering device; 72—bottom cover.

### DETAILED DESCRIPTION OF EMBODIMENTS

The technical solutions in the embodiments of the present disclosure will be clearly and completely described below in combination with the accompanying drawings in the embodiments of the present disclosure. Obviously, the embodiments described are only partial embodiments in the present disclosure and not all embodiments. Based on the embodiments in the present disclosure, all other embodiments obtained by persons skilled in the art without creative labor shall fall within the protection scope of the present disclosure.

It should be noted that the terms “first”, “second”, etc. in the specification and claims of the present disclosure and the above-mentioned accompanying drawings are used to distinguish similar objects and do not need to be used to describe a specific sequence or precedence order. It should be understood that the data used in this way can be interchanged where appropriate, so that the embodiments of the present disclosure described herein can be implemented in a sequence other than those illustrated or described here. Furthermore, the terms “include” and “have” as well as any variations of them are intended to cover non-exclusive inclusion.

In view of the deficiencies of the relevant technologies, the present disclosure provides the following solutions.

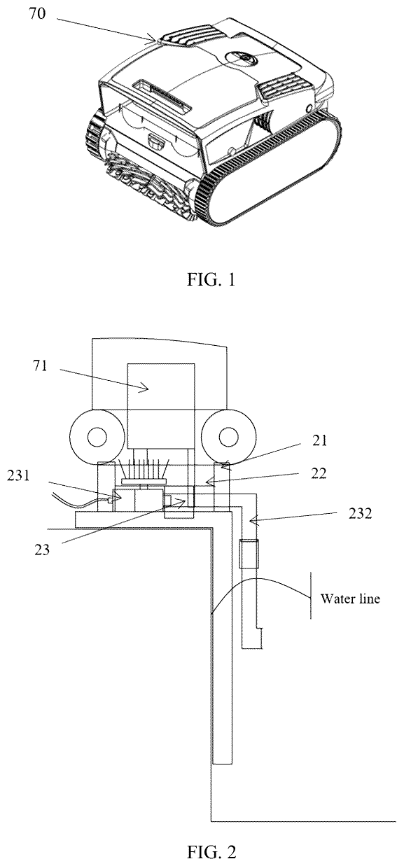

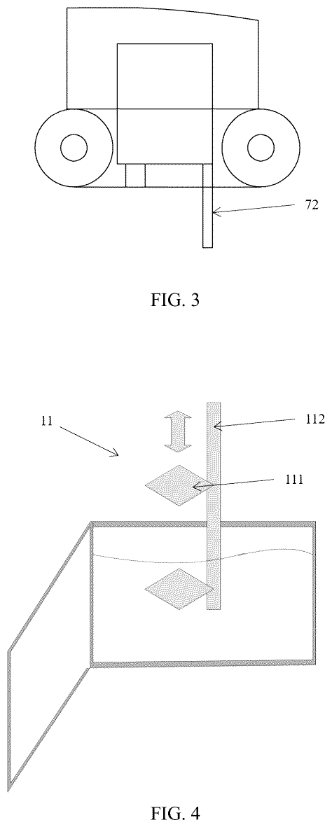

Referring to FIGS. 1-4, the present disclosure provides a garbage collection system, including a landing assistance mechanism 1, a base station 2 and a controller, wherein the base station 2 includes a holding section 21 for a pool automatic cleaning device, a garbage collection device 22 and a water flow guiding mechanism 23; the landing assistance mechanism 1 is used to assist the pool automatic cleaning device 70 in moving from an inside of the pool to the holding section 21 on a shore of the pool. When the pool automatic cleaning device 70 is located at the holding section 21, a filtering device 71 of the pool automatic cleaning device 70 is interconnected to the garbage collection device 22, and the controller is configured to control the water flow guiding mechanism 23 to perform water spraying, so as to move garbage in the filtering device 71 from the filtering device 71 to the garbage collection device 22.

It should be noted that when the pool automatic cleaning device needs to clear the garbage in the filtering device, the pool automatic cleaning device goes to the landing assistance mechanism, goes ashore by the landing assistance mechanism and moves to the base station for garbage collection.

Specifically, the base station includes the holding section for the pool automatic cleaning device, the garbage collection device and the water flow guiding mechanism. When the pool automatic cleaning device moves onto the holding section for the pool automatic cleaning device, the pool automatic cleaning device stops moving. Then, the filtering device of the pool automatic cleaning device is interconnected to the garbage collection device. In this way, one part of the garbage in the filtering device falls, due to the effect of gravity, into the garbage collection device for collecting. However, other part of the garbage is still adsorbed on a filter surface of the filtering device. Therefore, the water flow guiding mechanism is disposed to guide the water flow to flush the filtering device, enabling the garbage to go into the garbage collection device with the water flow.

In one embodiment, a water outlet of the water flow guiding mechanism is disposed below the filtering device, so that the water flow from the water outlet rinses at least a portion of the filtering device from a bottom of the filtering device to guide the garbage in the filtering device to flow into the garbage collection device.

Specifically, the water outlet of the water flow guiding mechanism includes a nozzle, which is disposed below the filtering device. In a case where the filtering device is interconnected to the garbage collection device, the nozzle may spray water in a circular pattern at an upward angle to wash the filtering device, thereby guiding the garbage into the garbage collection device.

Of course, the water flow guiding mechanism may also be a retractable and extendable configuration. In a case where the filtering device is interconnected to the garbage collection device, the nozzle extends into an interior of the filtering device to spray water in a circular pattern, which is more conducive to cleaning the interior of the filtering device.

In one embodiment, a water outlet of the water flow guiding mechanism is disposed above the filtering device or near a top of a garbage basket, so that the water flow from the water outlet rinses at least a portion of the filtering device from a top of the filtering device or a side of the filtering device to guide the garbage in the filtering device to flow into the garbage collection device.

Specifically, in the water flow guiding mechanism, the nozzle may be disposed, through pipes, above the filtering device or near a top of a garbage basket. By this way, the water flow flows from top to bottom for flushing, which is more conducive to guiding the garbage.

Specifically, the water flow guiding mechanism stretches upwards to allow the water outlet to reach the top of the filtering device.

In one embodiment, the water flow guiding mechanism is tubular or showerhead shaped.

In one embodiment, the water flow from the water outlet flows to an inside and/or outside of the filtering device.

In some possible embodiments, an upper cover of the pool automatic cleaning device may be opened, and the water flow from the nozzle may directly clean the filtering device from above the filtering device, thereby achieving a higher cleaning efficiency. Of course, the nozzle of the water flow guiding mechanism may also spray water flow into a water outlet at the top of the pool automatic cleaning device, and then the water flow enters the side of the filtering device through the pipes in the water pool cleaning device to flush the filtering device.

In one embodiment, the garbage collection device also includes a conveyor belt and a garbage accommodating device. The garbage in the filtering device is conveyed to the garbage accommodating device by the conveyor belt.

Specifically, in order to prevent the garbage collection device from getting clogged, the fallen part of the garbage may be conveyed to the garbage accommodating device by the conveyor belt. There is a dirt scraping device at the bottom of the conveyor belt, which may scrape all the remaining garbage into the garbage accommodating device. The accompanying water flow may be discharged after passing through a filter screen.

In one embodiment, the water flow guiding mechanism also includes a rotating nozzle, and the rotating nozzle is configured to spray water intermittently or in a pulsed manner.

Specifically, in order to enhance the cleaning efficiency, the water flow guiding mechanism also includes the rotating nozzle. By setting the rotating nozzle, a circular spraying water flow may be formed simultaneously to clean the filtering device in all directions. Furthermore, the water spray form is configured to spray water intermittently or in a pulsed manner, and the cleaning capacity is further enhanced through intermittent water spraying.

In one or more embodiments, in order to assist the pool automatic cleaning device in moving from the inside of the pool to the base station, a landing assistance mechanism is also configured, wherein the landing assistance mechanism includes at least one of the following forms.

A lifting device 11. The lifting device 11 is provided with a supporting surface 111 that is configured to move up and down. The pool automatic cleaning device is moved, by the supporting surface, from the inside of the pool to the holding section for the pool automatic cleaning device. For example, a guide column 112 may be disposed on the shore of the pool. The supporting surface may move up and down on the guide column. When the supporting surface is at the bottom, the pool cleaning device may move to the supporting surface in the pool, and then the supporting surface is controlled to move upwards to move the pool automatic cleaning device from the inside of the pool to the shore of the pool. The supporting surface may directly move the pool automatic cleaning device to the holding section for the pool automatic cleaning device or move the pool automatic cleaning device to a fixed path on the shore of the pool, and the pool automatic cleaning device may move along the fixed path to the holding section for the pool automatic cleaning device.

A climbing mechanism. The climbing mechanism is provided with a guiding surface. The pool automatic cleaning device moves, by the guiding surface, from the inside of the pool to the holding section for the pool automatic cleaning device. For example, one end of the guiding surface is connected to the inside of the pool, and the other end of the guiding surface is connected to or close to the holding section for the pool automatic cleaning device. The pool automatic cleaning device moves to the end of the guiding surface in the pool and climbs out of the water surface along the guiding surface to the holding section for the pool automatic cleaning device. Further, the guiding surface may be a common plane with an anti-slip structure, or a track structure with driving force, etc.

A hoisting mechanism. The hoisting mechanism is provided with an upward force-applying element. The pool automatic cleaning device is moved, by the upward force-applying element, from the inside of the pool to the holding section for the pool automatic cleaning device. For example, the upward force-applying element may be a hook, which assists the pool automatic cleaning device to be moved from the inside of the pool and moves it to the holding section for the pool automatic cleaning device.

In one embodiment, the water flow guiding mechanism includes a suction device 231, a suction pipe 232 and a discharge pipe. When the suction device is working, the suction pipe sucks water from the inside of the pool or an external water pipe, and the discharge pipe discharges filtered water out of the garbage collection system.

Specifically, the water flow guiding mechanism pressurizes, through the suction device, the water flow in the suction pipe to form a spraying water flow to flush the filtering device. The water flow in the suction pipe may come from the inside of the pool or an external water pipe, and the filtered water may be discharged from the discharge pipe to the inside of the pool or other external areas (such as a sewer pipe).

In one embodiment, the suction device is disposed on the garbage collection device, the suction pipe, or the discharge pipe.

Specifically, the suction device is used to provide the power for the water flow movement and may be installed on the water flow pipe.

In one embodiment, the base station and/or at least part of the landing assistance mechanism may be disposed on a shore of the pool.

Specifically, the base station and/or at least part of the landing assistance mechanism may be disposed on the shore of the pool, thereby achieving garbage collection on the shore of the pool.

In one embodiment, a detection device is also included, and the detection device is used to detect whether the pool automatic cleaning device is properly connected to the holding section and/or whether a dirt amount in the filtering device reaches a collecting threshold. Whether the garbage collection system collects garbage is controlled based on a detection signal of the detection device.

The detection device also includes a first sensor and a second sensor. The controller controls whether the garbage collection system collects garbage based on the detection signals from the first sensor and the second sensor.

Furthermore, the base station is provided with a first sensor, and the first sensor is used to detect whether the pool automatic cleaning device is properly connected to the base station. The base station or the pool automatic cleaning device is provided with a second sensor, and the second sensor is used to detect the dirt amount in the filtering device.

From the above description, it can be known that the controller takes whether the pool automatic cleaning device is properly connected to the base station and whether the dirt amount in the filtering device needs to be collected as the basis for decision, and controls whether the garbage collection system collects the garbage according to the detection signals given by the corresponding sensors respectively.

In one embodiment, the filtering device further includes a bottom cover 72, and the bottom cover is configured to be open in a case where the garbage collection system is conducting garbage collection.

From the above description, it can be known that the openable bottom cover 72 is disposed. In this case, the bottom of the pool automatic cleaning device has a cover plate that can be opened in coordination with the bottom cover. In a case where the bottom cover needs to be opened, the cover plate is also opened. In this way, it is more conducive to the removal of garbage from the filtering device during garbage collection.

In one or more embodiments, a suction port at the bottom of the pool automatic cleaning device and a suction port of the filtering device are configured to be expanded in a case where the garbage collection system is conducting garbage collection.

From the above description, it can be known that the suction port at the bottom of the pool automatic cleaning device and the suction port of the filtering device can be adjusted, for example, through the control of an electric control valve. When the pool automatic cleaning device is working normally in the pool, the suction port at the bottom of the pool automatic cleaning device and the suction port of the filtering device can be adjusted to the conventional size, which can be used for normal suction of dirt. When garbage collection is conducted within the garbage collection system, the suction port at the bottom of the pool automatic cleaning device and the suction port of the filtering device can be expanded, which makes it more conducive to the removal of garbage from the filtering device during garbage collection.

In one embodiment, a wireless charging device is also included. When the pool automatic cleaning device is located at the holding section, the garbage collection system charges the pool automatic cleaning device by the wireless charging device.

From the above description, it can be known that the garbage collection system is also provided with a charging function. After the pool automatic cleaning device is moved onto the holding section, the wireless charging is also achieved, in addition to collecting the garbage.

Although the present disclosure has been described by optional embodiments, the present disclosure is not limited to the embodiments described here. Without departing from the protection scope of the present disclosure, the present disclosure also includes various changes and variations made.

In present disclosure, the positional words such as front, back, up and down involved are defined by the positions of the components in the accompanying drawings and the relative positional relationships among the components, merely for the clarity and convenience of expressing the technical solutions. It should be understood that the use of the positional words should not define the protection scope as claimed by the present disclosure.

In the absence of conflict, the above-mentioned embodiments and the features in the embodiments in the present disclosure may be combined with each other.

The above-mentioned disclosure is only a preferred embodiment of the present disclosure. Of course, this cannot be used to define the protection scope of the claims of the present disclosure. Therefore, the equivalent changes made according to the claims of the present disclosure still fall within the protection scope covered by the present disclosure.

I/we claim:

1. A garbage collection system, comprising a landing assistance mechanism, a base station and a controller, wherein:
the base station comprises a holding section for a pool automatic cleaning device, a garbage collection device and a water flow guiding mechanism;
the landing assistance mechanism is used to assist the pool automatic cleaning device in moving from an inside of a pool to the holding section on a shore of the pool;
wherein in a case where the pool automatic cleaning device is located at the holding section, a filtering device of the pool automatic cleaning device is interconnected to the garbage collection device, and the controller is configured to control the water flow guiding mechanism to perform water spraying, so as to move garbage in the filtering device from the filtering device to the garbage collection device.

2. The garbage collection system according to claim 1, wherein a water outlet of the water flow guiding mechanism is disposed below the filtering device, so that a water flow from the water outlet rinses at least a portion of the filtering device from a bottom of the filtering device to guide the garbage in the filtering device to flow into the garbage collection device.

3. The garbage collection system according to claim 1, wherein a water outlet of the water flow guiding mechanism is disposed above the filtering device or near a top of a garbage basket, so that a water flow from the water outlet rinses at least a portion of the filtering device from a top of the filtering device or a side of the filtering device to guide the garbage in the filtering device to flow into the garbage collection device.

4. The garbage collection system according to claim 3, wherein the water flow guiding mechanism stretches upwards to allow the water outlet to reach the top of the filtering device.

5. The garbage collection system according to claim 1, wherein the water flow guiding mechanism is tubular or showerhead shaped.

6. The garbage collection system according to claim 2, wherein the water flow from the water outlet flows to an inside and/or outside of the filtering device.

7. The garbage collection system according to claim 3, wherein the water flow from the water outlet flows to an inside and/or outside of the filtering device.

8. The garbage collection system according to claim 1, wherein the garbage collection device further comprises a conveyor belt and a garbage accommodating device, and the garbage in the filtering device is conveyed into the garbage accommodating device by the conveyor belt.

9. The garbage collection system according to claim 1, wherein the water outlet of the water flow guiding mechanism further comprises a rotating nozzle, and the rotating nozzle is configured to spray water intermittently or in a pulsed manner.

10. The garbage collection system according to claim 1, wherein the landing assistance mechanism comprises at least one of the following forms:
a lifting device which is provided with a supporting surface that is configured to move up and down, and the pool automatic cleaning device is moved, by the supporting surface, from the inside of the pool to the holding section for the pool automatic cleaning device;
a climbing mechanism which is provided with a guiding surface, and the pool automatic cleaning device moves, by the guiding surface, from the inside of the pool to the holding section for the pool automatic cleaning device; and
a hoisting mechanism which is provided with an upward force-applying element, and the pool automatic cleaning device is moved, by the upward force-applying element, from the inside of the pool to the holding section for the pool automatic cleaning device.

11. The garbage collection system according to claim 1, wherein the water flow guiding mechanism comprises a suction device, a suction pipe and a discharge pipe, and in a case where the suction device is working, the suction pipe sucks water from the inside of the pool or an external water pipe, and the discharge pipe discharges filtered water out of the garbage collection system.

12. The garbage collection system according to claim 11, wherein the suction device is disposed on the garbage collection device, the suction pipe, or the discharge pipe.

13. The garbage collection system according to claim 1, wherein the base station and/or at least part of the landing assistance mechanism is disposed on a shore of the pool.

14. The garbage collection system according to claim 1, wherein further comprising: a detection device which is used to detect whether the pool automatic cleaning device is properly connected to the holding section and/or whether a dirt amount in the filtering device reaches a collecting threshold, and whether the garbage collection system collects garbage is controlled based on a detection signal of the detection device.

15. The garbage collection system according to claim 1, wherein the filtering device further comprises a bottom cover, and the bottom cover is configured to be opened in a case where the garbage collection system is conducting garbage collection.

16. The garbage collection system according to claim 1, wherein a dirt suction port at a bottom of the pool automatic cleaning device and a dirt suction port of the filtering device are configured to be expanded in a case where the garbage collection system is conducting garbage collection.

17. The garbage collection system according to claim 1, wherein further comprising: a wireless charging device, and in a case where the pool automatic cleaning device is located at the holding section, the garbage collection system charges the pool automatic cleaning device by the wireless charging device.
